(19) United States
(12) Patent Application Publication
(10) Pub. No.: US 2005/0232353 A1
(43) Pub. Date: Oct. 20, 2005

(54) Subband video decoding mehtod and device

(75) Inventors: Arnaud Bourge, Paris (FR); Eric Barrau, Puteaux (FR); Marion Benetiere, Rueil-Malmaison (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/518,827

(22) PCT Filed: Jun. 18, 2003
(86) PCT No.: PCT/IB03/02779

§ 371 Date: Dec. 21, 2004

(30) Foreign Application Priority Data
Jun. 28, 2002 (EP) 02291621.7

(51) Int. Cl. H04N 7/12

(52) U.S. Cl. 375/240.16; 375/240.25; 375/240.12; 375/240.23; 375/240.11

(57) ABSTRACT

The invention relates to a video decoding method for the decompression of an input coded bitstream corresponding to an original video sequence. The sequence has been divided into successive groups of frames (GOFs) and coded by means of a three-dimensional subband video coding method. According to the invention, the decoding method is iterative and comprises as many iterations as the number of couples of frames in each GOF, each iteration itself including, for the reconstruction of each successive couple of frames of each GOF, the sub-steps of decoding the coded bitstream that corresponds to the current GOF, storing, from the decoded bitstream thus obtained, only the data related to the current couple of frames and appropriate subbands containing some information on at least one frame of said current couple of frames, and, from said related data and said appropriate subbands, synthesizing the two frames of said current couple of frames.

### FIELD OF THE INVENTION

The present invention generally relates to the field of video compression and, more particularly, to a video decoding method for the decompression of a coded bitstream corresponding to an original video sequence that has been divided into successive groups of frames (GOFs) and coded by means of a 3D subband video coding method comprising the following steps:
a temporal filtering step—with or without motion compensation—performed on each successive couple of frames in each GOF of said sequence;
a spatial analysis step, performed on said filtered sequence;
an entropy coding step, performed on said analyzed filtered sequence, and on motion vectors in case of motion compensation;
an arithmetic coding step, applied to the coded sequence thus obtained and delivering said coded bitstream.

The invention also relates to a decoding device for carrying out said decoding method, to a memory medium including a code for performing the steps of said decoding method, and to a corresponding apparatus.

### BACKGROUND OF THE INVENTION

From MPEG-1 to H.264, standard video compression schemes were based on so-called hybrid solutions (an hybrid video encoder uses a predictive scheme where each frame of the input video sequence is temporally predicted from a given reference frame, and the prediction error thus obtained by difference between said frame and its prediction is spatially transformed, for instance by means of a bi-dimensional DCT transform, in order to get advantage of spatial redundancies). A different approach, later proposed, consists in processing a group of frames (GOF) as a three-dimensional (3D, or 2D+t) structure and spatio-temporally filtering it in order to compact the energy in the low frequencies (as described for instance in “Three-dimensional subband coding of video”, C. I. Podilchuk and al., IEEE Transactions on Image Processing, vol. 4, no 2, February 1995, pp. 125-139). Moreover, the introduction of a motion compensation step in such a 3D subband decomposition scheme allows to improve the overall coding efficiency and leads to a spatio-temporal multiresolution (hierarchical) representation of the video signal thanks to a subband tree, as depicted in FIG. 1.

The 3D wavelet decomposition with motion compensation, illustrated in said FIG. 1, is similarly applied to successive groups of frames (GOFs). Each GOF of the input video, including in the illustrated case eight frames F1 to F8, is first motion-compensated (MC) in order to process sequences with large motion, and then temporally filtered (TF) using Haar wavelets (the dotted arrows correspond to a high-pass temporal filtering, while the other ones correspond to a low-pass temporal filtering). Three successive stages of decomposition are shown (L and H=first stage; LL and LH=second stage; LLL and LLH=third stage). The high frequency subbands of each temporal level (H, LH and LLH in the above example) and the low frequency subband(s) of the deepest one (LLL) are spatially analyzed through a wavelet filter. An entropy encoder then allows to encode the wavelet coefficients resulting from the spatio-temporal decomposition (for example, by means of an extension of the 2D-SPIHT, originally proposed by A. Said and W. A. Pearlman in “A new, fast, and efficient image codec based on set partitioning in hierarchical trees”, IEEE Transactions on Circuits and Systems for Video Technology, vol. 6, no 3, June 1996, pp. 243-250, to the present 3D wavelet decomposition, in order to efficiently encode the final coefficient bitplanes with respect to the spatio-temporal decomposition structure).

However, all the 3D subband solutions suffer from the following drawback: since an entire GOF is processed at once, all the pictures in the current GOF have to be stored before being spatio-temporally analyzed and encoded. The problem is the same at the decoder side, where all the frames of a given GOF are decoded together.

### SUMMARY OF THE INVENTION

It is therefore a first object of the invention to propose a decoding method allowing to decrease the high memory demand of the 3D subband approach.

To this end, the invention relates to a video decoding method such as defined in the introductory part of the description and which is further characterized in that it is iterative and comprises as many iterations as the number of couples of frames in each GOF, each iteration itself including, for the reconstruction of each successive couple of frames of each GOF, the sub-steps of:
decoding the part of the coded bitstream that corresponds to the current GOF;
from the decoded bitstream thus obtained, storing only the data related to the current couple of frames and the appropriate subbands containing some information on at least one frame of said current couple of frames;
from said related data and said appropriate subbands, synthesizing the two frames of said current couple of frames.

It is also an object of the invention to propose a decoding device allowing to carry out said decoding method, a memory medium including a code for performing the steps of said decoding method, and a corresponding apparatus.

### BRIEF DESCRIPTION OF DRAWINGS

The present invention will now be described, by way of example, with reference to the accompanying drawings in which:

FIG. 1 illustrates a 3D subband decomposition, performed in the present case on a group of eight frames;

FIG. 2 shows, among the subbands obtained by means of said decomposition, the subbands that are transmitted and the bitstream thus formed;

FIGS. 3 to 6 illustrate, in the decoding method according to the invention, the operations iteratively performed for decoding the coded bitstream;

FIG. 7 shows an example of a decoding device for the implementation of the decoding method according to the invention.

### DETAILED DESCRIPTION OF THE INVENTION

As indicated above, the amount of frames that have to be stored at the same time when processing a whole GOF is really a problem, and could be a reason to prevent 3D subband solutions from being adopted as standards. For instance, with a GOF having a typical size of 16 frames, at the decoder side where all the frames of the GOF are decoded together, one must be able to decode 16 subbands at the same time and additionally to store 16 frames before playing them. Moreover, for real-time playing, those 16 frames must be decoded before the frames of the previous GOF are all played. In fact, if N is the number of frames in a GOF and M the minimum number of frames to be played in real-time while decoding the next N frames, the decoder needs ((2×N)+M) memory frames to be stored at the same time.

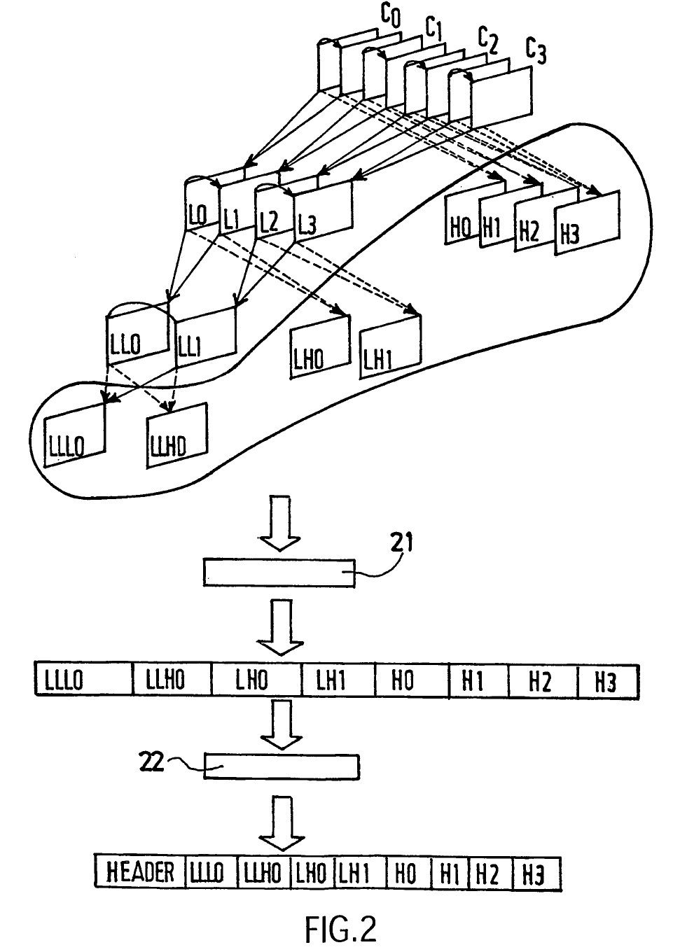

The principle of the invention is then to propose a decoding method in which a branch-by-branch reconstruction of the 3D structure is performed, instead of a reconstruction of the entire tree at once: less data has to be stored with such a solution, as it will be shown. As illustrated in FIG. 2 in the case of a GOF of eight frames for the sake of simplicity of the figure, the frames F1 to F8 are grouped into four couples of frames C0, C1, C2, C3. At the end of the first step of the temporal decomposition of the original sequence, low frequency temporal subbands L0, L1, L2, L3 and high frequency temporal subbands H0, H1, H2, H3 are available. While the subbands H0 to H3 are coded and transmitted, the subbands L0 to L3 are further decomposed: at the end of this second step of the decomposition, low frequency temporal subbands LL0, LL1 and high frequency temporal subbands LH0, LH1 are available. Similarly, while the subbands LH0, LH1 are coded and transmitted, the subbands LL0, LL1 are further decomposed and, at the end of the third step of decomposition (the last one in the illustrated case), a low frequency temporal subband LLL0 and a high frequency temporal subband LLH0 are available and will be coded and transmitted. The whole set of transmitted subbands is surrounded by a black line in FIG. 2.

It then appears that only the subbands H0, LH0, LLH0 and LLL0 are needed to decode the first two frames F1, F2 (i.e. the couple C0) of the GOF. Furthermore, the first subband H0 contains some information only on these two first frames F1,F2. So, once these frames F1, F2 are decoded, the first subband H0 becomes useless and can be deleted and replaced: the next subband H1 is now loaded in order to decode the next couple C1 including the two frames F3, F4. Only the subbands H1, LH0, LLL0 and LLH0 are now needed to decode these frames F3, F4 and, as previously for H0, the subband H1 contains some information only on these two frames F3, F4. So, once these two frames F3, F4 are decoded, the second subband H1 can be deleted, and replaced by H2. And so on: these operations are repeated for F5,F6, F7,F8, etc (in the general case, for all the successive couples of frames of the GOF). The bitstream (the illustrated organization of which is only an example that does not limit the scope of the invention at the decoding side) thus formed for each successive GOF may be encoded by means of an entropy coder followed by an arithmetic coder (for instance referenced 21 and 22 respectively).

The practical operations are then the following. The part of the coded bitstream corresponding to the current GOF is decoded a first time, but only the coded part that, in said bitstream, corresponds to the first couple of frames C0 (the two first frames F1 and F2) and the subbands H0, LH1, LLL0, LLH0 is, in fact, stored and decoded. When the first two frames F1,F2 have been decoded, the first H subband, referenced H0, becomes useless and its memory space can be used for the next subband to be decoded. The coded bitstream is therefore read a second time, in order to decode the second H subband, referenced H1, and the next couple of frames C1 (F3,F4). When this second decoding step has been performed, said subband H1 becomes useless and the first LH subband too (referenced LH0). They are consequently deleted and replaced by the next H and LH subbands (respectively referenced H2 and LH1), that will be obtained thanks to a third decoding of the same input coded bitstream, and so on.

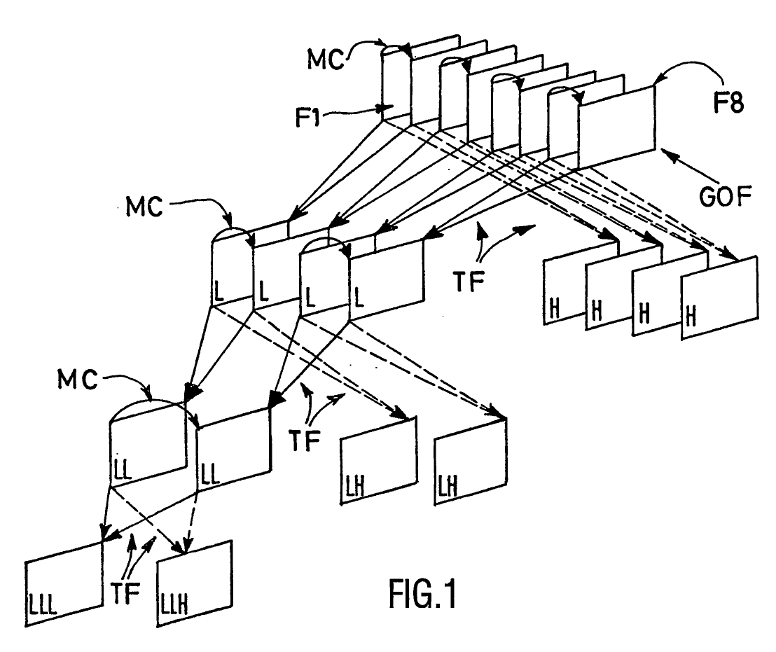

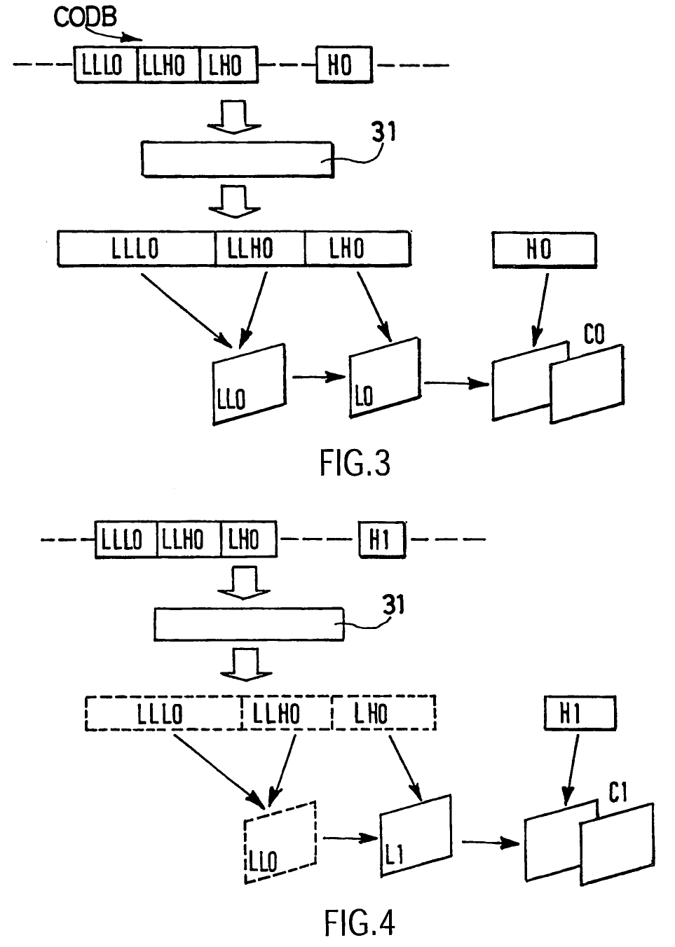

This multipass decoding solution, comprising an iteration per couple of frames in the GOF, may be detailed with reference to FIGS. 3 to 6. During the first iteration, the coded bitstream CODB received at the decoding side is decoded by an arithmetic decoder 31, but only the decoded parts corresponding to the first couple of frames C0 are stored, i.e. the subbands LLL0, LLH0, LH0 and H0 (see FIG. 3). With said subbands, the inverse operations, with respect to those illustrated in FIG. 1, are then performed:
the decoded subbands LLL0 and LLH0 are used to synthesize the subband LL0;
said synthesized subband LL0 and the decoded subband LH0 are used to synthesize the subband L0;
said synthesized subband L0 and the decoded subband H0 are used to reconstruct the two frames F1, F2 of the couple of frames C0.

When this first decoding step is achieved, a second one can begin. The coded bitstream is read a second time, and only the decoded parts corresponding to the second couple of frames C1 are now stored: the subbands LLL0, LLH0, LH0 and H1 (see FIG. 4). In fact, the dotted information of FIG. 4 (LLL0, LLH0, LL0, LH0) can be reused from the first decoding step (this is especially true for the bitstream information after the arithmetic decoding, because buffering this compressed information is not really memory consuming). With these subbands, the following inverse operations are now performed:
the decoded subband LLL0 and LLH0 are used to synthesize the subband LL0;
said synthesized subband LL0 and the decoded subband LH0 are used to synthesize the subband L1;
said synthesized subband L1 and the decoded subband H1 are used to reconstruct the two frames F3, F4 of the couple of frames C1.

When this second decoding step is achieved, a third one can begin similarly. The coded bitstream is read a third time, and only the decoded parts corresponding to the third couple of frames C2 are now stored: the subbands LLL0, LLH0, LH1 and H2 (see FIG. 5). As previously, the dotted information of FIG. 5 (LLL0, LLH0) can be reused from the first (or second) decoding step. The following inverse operations are performed:
the decoded subbands LLL0 and LLH0 are used to synthesize the subband LL1;
said synthesized subband LL1 and the decoded subband LH1 are used to synthesize the subband L2;
said synthesized subband L2 and the decoded subband H2 are used to reconstruct the two frames F5, F6 of the couple of frames C2.

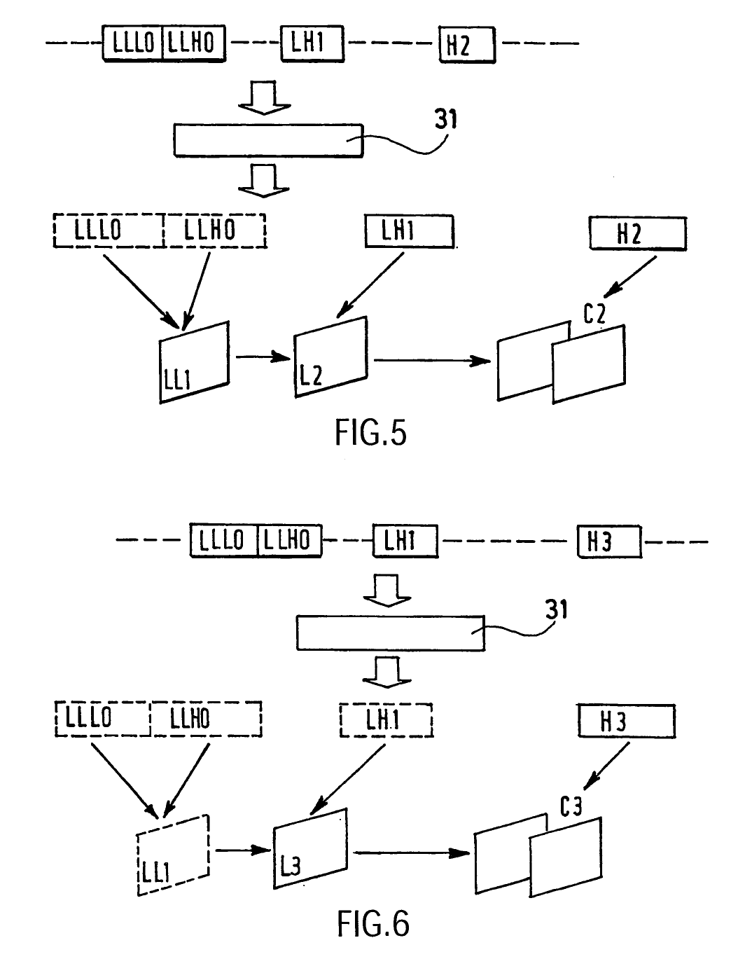

When this third decoding step is achieved, a fourth one can begin similarly. The coded bitstream is read a fourth time (the last one for a GOF of four couples of frames), only the decoded parts corresponding to the fourth couple of frames C3 being stored: the subbands LLL0, LLH0, LH1 and H3 (see FIG. 6). Similarly, the dotted information of FIG. 6 (LLL0, LLH0, LL1, LH1) can be reused from the third decoding step. The following inverse operations are performed:
the decoded subbands LLL0 and LLH0 are used to synthesize the subband LL1;
said synthesized subband LL1 and the decoded subband LH1 are used to synthesize the subband L3;
said synthesized subband L3 and the decoded subband H3 are used to reconstruct the two frames F7, F8 of the couple of frames C3.

This procedure is repeated for all the successive GOFs of the video sequence. When decoding the coded bitstream according to this procedure, at most two frames (for example F1, F2) and four subbands (with the same example, H0, LH0, LLH0, LLL0) have to be stored at the same time. More generally, if N is the number of frames in a GOF (N=2ⁿ preferably), only a limited number of subbands and frames are needed at the same time for decoding the bitstream, instead of N subbands and N frames.

This solution has the main advantage of working in any case, regardless of the technique used to implement the encoding method (as nothing has to be changed at the encoding side, the solution can be adapted to any 3D subband video decoding technique by simply changing the decoder).

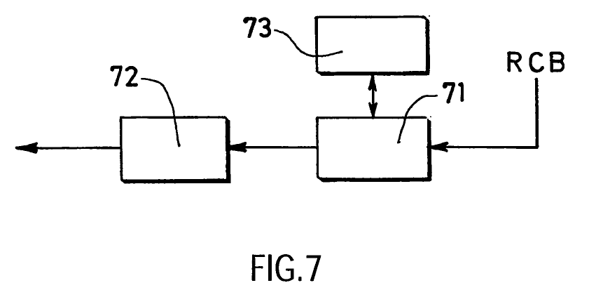

At the decoding side (or in a server), the corresponding decoding method may be implemented in a decoding device such as illustrated in FIG. 7 and which comprises the following main modules. The received coded bitstream RCB is first processed by a decoding device 71, comprising for instance in series an arithmetic decoding stage and an entropy decoding stage, and provided for decoding the coded bitstream including the coded coefficients and the coded motion vectors. The decoded coefficients and motion vectors are then received by an inverse 3D wavelet transform circuit 72 which is provided for reconstructing an output video sequence corresponding to the original one. The decoding device may also comprise a resource controller 73, for verifying before each motion vector decoding process the amount of bit budget already spent and deciding, on the basis of said amount, if the remaining parts of the coded data have to be decoded or not.

The previous description, presented for purposes of illustration and description, was not intended to limit the invention to the precise form disclosed. Many variations or modifications are possible in light of the above teachings and are included within the scope of the invention. The encoding and decoding devices may be for instance of the type described in the document “A fully scalable 3D subband video codec”, V. Bottreau and al., Proceedings of IEEE Conference on Image Processing (ICIP2001), vol. 2, pp. 1017-1020, Thessalonild, Greece, Oct. 7-10, 2001.

It may also be understood that the decoding device according to the invention can be implemented in hardware, software (the coded bitstream being then processed in accordance with one or more software programs or codes stored in a memory medium and executed by means of a processor in order to reconstruct output frames corresponding to the original video sequence), or a combination of software and hardware, without excluding that a single item of hardware or software can carry out several functions or that an assembly of items of hardware or software or both carry out a single function. The described decoding method and device may be implemented by any type of computer system or other apparatus adapted for carrying out the method described herein. A typical combination of hardware and software could be a general-purpose computer system with a computer program that, when loaded and executed, controls the computer system such that it carries out the method described herein. A specific use computer, containing specialized hardware for carrying out one or more of the functional tasks of the invention, could alternatively be utilized.

The present invention can also be embedded in a computer program product, which comprises all the features enabling the implementation of the method and functions described herein, and which—when loaded in a computer system—is able to carry out this method and these functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

1. A video decoding method for the decompression of an input coded bitstream corresponding to an original video sequence that had been divided into successive groups of frames (GOFs) and coded by means of a three-dimensional subband video coding method comprising, in each GOF of said sequence, the following steps:
a temporal filtering step, performed on each successive couple of frames;
a spatial analysis step, performed on said filtered sequence;
an entropy coding step, performed on said analyzed, filtered sequence;
an arithmetic coding step, applied to the coded sequence thus obtained;
said decoding method, applied to the coded bitstream thus delivered for the current GOF, being further characterized in that it is iterative and comprises as many iterations as the number of couples of frames in each GOF, each iteration itself including, for the reconstruction of each successive couple of frames of each GOF, the sub-steps of:
decoding said coded bitstream;
from the decoded bitstream thus obtained, storing only the data related to the current couple of frames and the appropriate subbands containing some information on at least one frame of said current couple of frames;
from said related data and said appropriate subbands, synthesizing the two frames of said current couple of frames.

2. A video decoding method for the decompression of an input coded bitstream corresponding to an original video sequence that had been divided into successive groups of frames (GOFs) and coded by means of a three-dimensional subband video coding method comprising the following steps:
a motion estimation step, performed on said original sequence;
a motion compensated temporal filtering step, performed in each GOF of said sequence, on each successive couple of frames;
a spatial analysis step, performed on said filtered sequence;
an entropy coding step, performed on said analyzed, filtered sequence and on motion vectors obtained by means of said motion estimation step;
an arithmetic coding step, applied to the coded sequence thus obtained and delivering said coded bitstream;
said decoding method being further characterized in that it is iterative and comprises as many iterations as the number of couples of frames in each GOF, each iteration itself including, for the reconstruction of each successive couple of frames of each GOF, the sub-steps of:
decoding said coded bitstream;
from the decoded bitstream thus obtained, storing only the data related to the current couple of frames and the appropriate subbands containing some information on at least one frame of said current couple of frames;
from said related data and said appropriate subbands, synthesizing the two frames of said current couple of frames.

3. A video decoding device for the decompression of an input coded bitstream corresponding to an original video sequence that had been divided into successive groups of frames (GOFs) and coded by means of a three-dimensional subband video coding method comprising, in each GOF of said sequence, the following steps:
a temporal filtering step, performed on each successive couple of frames;—a spatial analysis step, performed on said filtered sequence;
an entropy coding step, performed on said analyzed, filtered sequence;
an arithmetic coding step, applied to the coded sequence thus obtained and delivering said coded bitstream;
said decoding device being further characterized in that it comprises:
(1) means for decoding said coded bitstream;
(2) means for storing, from the decoded bitstream thus obtained, only the data related to the current couple of frames and the appropriate subbands containing some information on at least one frame of said current couple of frames;
(3) means for synthesizing the two frames of said current couple of frames from said related data and said appropriate subbands;
(4) means for repeating as many times as the number of couples of frames in each GOF the successive steps performed by said decoding, storing and synthesizing means.

4. A video decoding device for the decompression of an input coded bitstream corresponding to an original video sequence that had been divided into successive groups of frames (GOFs) and coded by means of a 3D subband video coding method comprising the following steps:
a motion estimation step, performed on said original sequence;
a motion compensated temporal filtering step, performed, in each GOF of said sequence, on each successive couple of frames;
a spatial analysis step, performed on said filtered sequence;
an entropy coding step, performed on said analyzed, filtered sequence and on motion vectors obtained by means of said motion estimation step;
an arithmetic coding step, applied to the coded sequence thus obtained and delivering said coded bitstream;
said decoding device being further characterized in that it comprises:
(1) means for decoding said coded bitstream that corresponds to the current GOF;
(2) means for storing, from the decoded bitstream thus obtained, only the data related to the current couple of frames and the appropriate subbands containing some information on at least one frame of said current couple of frames;
(3) means for synthesizing the two frames of said current couple of frames from said related data and said appropriate subbands;
(4) means for repeating as many times as the number of couples of frames in each GOF the successive steps performed by said decoding, storing and synthesizing means.

5. A memory medium including a computer readable code for the decompression of an input coded bitstream corresponding to an original video sequence that had been divided into successive groups of frames (GOFs) and coded by means of a three-dimensional subband video coding method comprising the following steps:
a temporal filtering step—with or without motion compensation—performed, in each GOF of said sequence, on each successive couple of frame;
a spatial analysis step, performed on said filtered sequence;
an entropy coding step, performed on said analyzed, filtered sequence and on motion vectors in case of motion compensation;
an arithmetic coding step, applied to the coded sequence thus obtained and delivering said coded bitstream;
said code comprising:
a code for decoding the said coded bitstream;
a code for storing, from the decoded bitstream thus obtained, only the data related to the current couple of frames and the appropriate subbands containing some information on at least one frame of said current couple of frames;
a code for synthesizing the two frames of said current couple of frames from said related data and said appropriate subbands;
a code for repeating as many times as the number of couples of frames in each GOF the successive steps performed by said decoding, storing and synthesizing codes.

6. An apparatus for the decompression of an input coded bitstream corresponding to an original video sequence that had been divided into successive groups of frames (GOFs) and coded by means of a three-dimensional subband video coding method comprising the following steps:
a temporal filtering step—with or without motion compensation—performed, in each GOF of said sequence, on each successive couple of frames;
a spatial analysis step, performed on said filtered sequence;
an entropy coding step, performed on said analyzed, filtered sequence and on motion vectors in case of motion compensation;
an arithmetic coding step, applied to the coded sequence thus obtained and delivering said coded bitstream;
said apparatus comprising a memory which stores executable code and a processor which executes the code stored in the memory so as to:
decode said coded bitstream;
store, from the decoded bitstream thus obtained, only the data related to the current couple of frames and the appropriate subbands containing some information on at least one frame of said current couple of frames;
synthesize the two frames of said current couple of frames from said related data and said appropriate subbands;
repeat as many times as the number of couples of frames in each GOF these decoding, storing and synthesizing operations applied to the current couple of frames.
